(19) United States
(12) Patent Application Publication
(10) Pub. No.: US 2003/0227231 A1
(43) Pub. Date: Dec. 11, 2003

(54) Doubly-excited brushless alternator

(76) Inventor: Vlado Ostovic, Weinheim (DE)

Correspondence Address: VLADO OSTOVIC, Muckensturmerstr. 25, Weinheim, 69469, DE

(21) Appl. No.: 10/393,773

(22) Filed: Jan. 29, 2003

(30) Foreign Application Priority Data
Jan. 30, 2002 (DE) 102 03 508

(51) Int. Cl. H02K 1/00

(52) U.S. Cl. 310/254; 310/216

(57) ABSTRACT

An electric machine that can be used as an alternator in a vehicle has an outer and an inner stator. The outer stator has two coaxial cores shifted to each other in axial direction and separated from each other by nonmagnetic material. Both cores of the outer stator are slotted and carry the armature winding. The inner stator has a core and an axially wound field winding. The rotor assembly has two magnetic flux modifying members and a plurality of radially magnetized permanent magnets. The magnetic flux modifying members direct the flux created by the field winding into the first outer stator core. The flux created by permanent magnets goes through the second outer stator core. The field current is bi-directional, providing for a better control of induced voltage in the armature winding.

### BACKGROUND OF THE INVENTION

1. Technical Field of the Invention

The present invention relates generally to electrical machines, and, more particularly, to synchronous machines for generation of electric power in vehicles.

2. Description of the Prior Art

Claw-pole, or Lundell alternators are almost the sole converters of mechanical into electrical energy in today's vehicles. Their simple construction—the rotor with only one, axially wound field coil for any number of pole pairs—along with a low manufacturing price make them the choice number one in the power range up to several kW. Beyond this power limit the rotor construction begins to show its weaknesses, the cooling problem of the field coil being the strongest of them. This is the main reason for numerous adaptations of conventional Lundell generator, most of them proposing additional permanent magnet(s) on the rotor side. Modified Lundell generators with annular permanent magnets are disclosed in U.S. Pat. No. 3,555,327, issued to Terry, in U.S. Pat. No. 4,882,515, issued to Radomski, in U.S. Pat. No. 4,959,577, issued to Radomski, U.S. Pat. No. 4,980,595, issued to Arora, and in U.S. Pat. No. 5,177,391, issued to Kusase. Several patents disclose modified Lundell alternators with tangentially oriented rotor magnets, including U.S. Pat. No. 5,693,995, issued to Syverson, U.S. Pat. No. 5,747,909, issued to Syverson and Francis, U.S. Pat. No. 5,753,989, issued to Syverson and Curtiss, and U.S. Pat. No. 6,236,134, issued to Syverson. Modified Lundell generators with radially mounted permanent magnets are disclosed among others in U.S. Pat. No. 5,130,595, issued to Arora, U.S. Pat. No. 5,552,651, issued to Radomski, U.S. Pat. No. 5,663,605, issued to Evans and Schultz, U.S. Pat. No. 5,710,471, issued to Syverson and Curtiss and in U.S. Pat. No. 6,455,978, issued to Krefta and Reiter. Probably the largest number of U.S. patents is granted to the disclosures related to modified Lundell alternators with permanent magnets between pole fingers, including U.S. Pat. No. 5,543,676, issued to York and Harris, U.S. Pat. No. 5,747,913, issued to Amlee, Matuoka, Rausch and Otipoby, U.S. Pat. No. 5,825,116, issued to Ishikawa, U.S. Pat. No. 5,892,313, issued to Harris and York, U.S. Pat. No. 5,965,967, issued to Liang, Miller and Xu, U.S. Pat. No. 5,973,435, issued to Irie and Ishikawa, U.S. Pat. No. 6,011,343, issued to Taniguchi, U.S. Pat. No. 6,013,968, issued to Lechner, Shendi and Briand, U.S. Pat. No. 6,144,138, issued to Ragaly and U.S. Pat. No. 6,448,680, issued to Akemakou. U.S. Pat. No. 5,793,143, issued to Harris and York is related to permanent magnets mounted on the rotor fan.

Although those designs just mentioned may have desirable features and may prove to be well manufacturable, alternative designs may provide superior power output. Thus, an alternator that is considerably robust, and that can provide significantly improved power output, particularly at low speeds, and which can do so in a simply manufacturable design, will provide advantages over the prior art.

### SUMMARY OF THE INVENTION

The present invention provides an electric machine. The electrical machine includes an outer and an inner stator and a rotor rotateably mounted within a stator. The outer stator has two annular cores and the inner stator has a cylindrical core. The outer stator cores are coaxially mounted within the housing and shifted axially to each other. Each of the two outer stator cores can be laminated, and they are separated from each other by a ring of non-magnetic material. The outer stator cores are slotted, and carry a multiphase lap or wave armature winding in the slots. The inner, cylindrical stator comprises a magnetic core and an axially wound stationary coil which carries the field current. The magnetic core of the inner stator may be hollow. The rotor having an axis of rotation comprises a first magnetic flux modifying member having a plurality of axially extending pole-forming magnetic segments fixed on a ring of magnetic material and a second magnetic flux modifying member having a plurality of axially extending pole-forming magnetic segments fixed on a ring of magnetic material, the axially extending pole-forming magnetic segments of the first magnetic flux modifying member alternatively intermeshed with the axially extending pole-forming magnetic segments of the second magnetic flux modifying member. The magnetic flux modifying members in the disclosed machine change the field flux linked by the armature winding(s) as a function of the rotor shift, thus having a similar role as claw poles in a claw-pole or Lundell alternator. The pole-forming magnetic segments in the disclosed machine have a similar role as the pole fingers in a claw-pole, or Lundell alternator. The rotor is separated from the two cores of the outer stator by the outer air gap. Another, inner air gap exists between the rotor and inner stator. The second magnetic flux modifying member of the rotor is mounted on the rotor shaft and carries a non-magnetic hollow cylinder on the inner sides of the second pole-forming magnetic segments. The first magnetic flux modifying member is mounted on the non-magnetic hollow cylinder in such a manner, that the inner surfaces of the pole-forming magnetic segments of the first magnetic flux modifying member lie on the outer surface of the non-magnetic cylinder. The first magnetic flux modifying member has in addition an axial extension in a form of a hollow magnetic cylinder. Further, the rotor comprises a plurality of permanent magnets mounted on the said hollow magnetic cylinder of the axial extension of the first magnetic flux modifying member. The permanent magnets are radially magnetized. The N-pole magnets coincide tangentially with first pole fingers, and the S-pole magnets coincide tangentially with second pole fingers.

The embodiment of this invention is an alternator that provides a significantly higher power output, particularly at low speeds, over other claw pole alternator designs. The disclosed alternator is simply manufacturable, an advantage over many other designs. It does not have slip rings and brushes for the field coil, an advantageous feature over many other designs that increases robustness and helps much better utilize the limited packaging volume of the alternator. For these reasons, the present invention provides advantages over the prior art.

### BRIEF DESCRIPTION OF THE DRAWINGS

These and other features, aspects and advantages of the present invention will become better understood with regard to the following description, appended claims and accompanying drawings where:

FIG. 1 is a perspective view of an electric machine according to the embodiment of the present invention.

FIG. 2 is an exploded view of the rotor of the disclosed machine showing separately the rotor assembly and the inner stator.

### DETAILED DESCRIPTION OF THE PREFERRED EMBODIMENTS

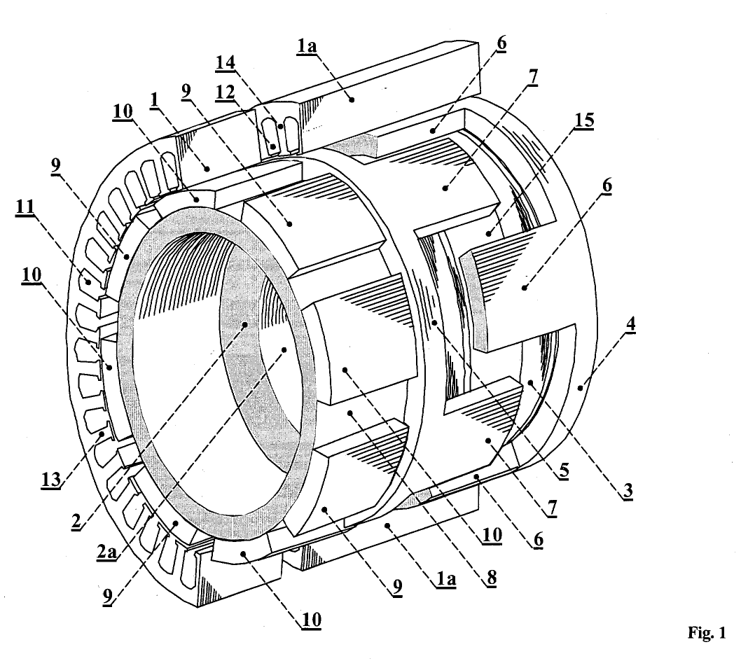

Referring now to FIG. 1, an electrical machine according to the embodiment of the present invention will be described. The cores 1 and 1a of the outer stator have axially extending slots 11 and 12, respectively, in which the armature multiphase winding (not shown) is disposed. Those skilled in the art will recognize that the axially extending slots 11 and 12 can carry any type of electric machine winding, such as concentric, lap, wave etc. Teeth 13 separate slots in the outer stator core 1, and teeth 14 in the outer stator core la from each other. The outer stator cores 1 and 1a are preferably constructed of iron laminations, each punched with the cross-sectional features shown in FIG. 1. Although the outer stator cores 1 and 1a are preferably constructed of laminations, the present invention is not so limited. By way of example, the outer stator cores 1 and 1a can also be made solid, as opposed to laminated. Each stator winding conductor goes through a slot 11 in the outer stator core 1, continues axially through the space between the outer stator cores 1 and 1a and then comes into a corresponding slot 12 in the outer stator core 1a, said corresponding slot 12 being coaxial with said slot 11 in the stator core 1. The magnetically conducting rotor cylinder 8 carries a plurality of permanent magnets on its outer surface, said permanent magnets having alternating magnetic polarity. Permanent magnets 9 have all the N-polarity, and permanent magnets 10 have all the S-polarity. Magnetic flux of permanent magnets 9 goes radially through the outer air gap into the teeth 13 of the outer stator core 1, following through the stator core 1 yoke, back to the stator core 1 teeth, outer air gap, permanent magnets 10 and then to the rotor cylinder 8.

The body of the inner stator 2 may have a coaxial hole 2a in order to allow for the rotor shaft to go along the whole machine. The inner stator has an axially wound coil 3 which carries the field current of the generator.

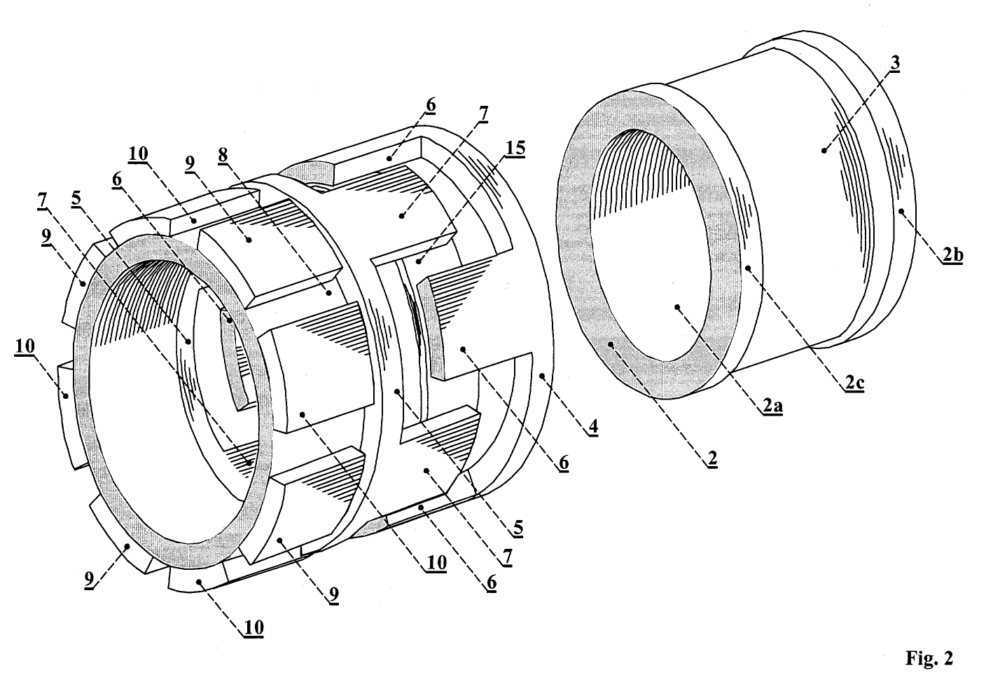

Referring now to FIG. 2, further details of the inner stator part and the rotor will be described. Magnetic flux generated by field current in coil 3 leaves the iron core of the inner stator 2 through the core lateral surface 2c, crosses the inner air gap, and enters radially into the ring 5 of the first magnetic flux modifying member, where it changes its direction. From the ring 5 the flux goes axially into the pole forming magnetic segments 7 of the first magnetic flux modifying member, said pole forming magnetic segments 7 all having the same magnetic polarity. In the pole forming magnetic segments 7 the flux changes its direction into radial, crosses the outer air gap and enters radially into teeth 14 of the outer stator core 1a. On its way through the outer stator core 1a the flux of the field coil goes further through the yoke, and than through the stator teeth 14 into the pole forming magnetic segments 6 of the second magnetic flux modifying member. The pole forming magnetic segments 6 have an opposite magnetic polarity to the polarity of the pole forming magnetic segments 7. From the second pole forming magnetic segments 6 the magnetic flux goes into to the ring 4 and then radially through the inner air gap into the inner stator surface 2b.

The field current flowing through the coil 3 can be either positive, or negative. The reason for such bi-directional current will become apparent during the upcoming discussion.

Referring to FIGS. 1 and 2 the operation of disclosed alternator will now be discussed. With current flow in one direction (say positive) in field coil 3, all pole forming magnetic segments 7 will have magnetic N- polarity, and all pole forming magnetic segments 6 will have magnetic S-polarity. Since the magnets 9 all have N-polarity, and magnets 10 all have S-polarity, the flux in the outer stator core 1a induces at certain rotor speed the voltages in the stator winding conductors which have the same polarity as the voltages induced by the flux of permanent magnets 9 and 10. As a result, the total induced voltage in each stator conductor increases with positive field current. If the field current becomes negative, the rotor fingers 7 become magnetically S-poles, and rotor fingers 6 magnetically N-poles. The induced voltages in stator conductor axial sections in stator cores 1 and 1a oppose each other, thus decreasing the total induced voltage in the armature winding.

It will be now appreciated that there has been presented a synchronous alternator with field coil and permanent magnets. The rotor of the presented machine is built out of magnetic flux modifying members along with a magnetic hollow cylinder. A plurality of permanent magnets is placed on the rotor magnetic hollow cylinder. The presented machine has two outer stator cores, said outer stator cores carrying a common armature winding, and an inner stator, said inner stator carrying an axially wound field coil.

While the invention has been described with particular reference to a preferred embodiment, it will be understood by those skilled in the art that various changes may be made and equivalents may be substituted for elements of the preferred embodiment without departing from invention. As is evident from the foregoing description, certain aspects of the invention are not limited to the particular details of the examples illustrated, and it is therefore contemplated that other modifications and applications will occur to those skilled in the art. It is accordingly intended that the claims shall cover all such modifications and applications as do not depart from the true spirit and scope of the invention.

What is claimed is:

1. An electrical machine comprising:
an outer stator assembly supported by the housing, said outer stator assembly comprising two coaxially disposed magnetic cores, said cores being axially separated from each other by a nonmagnetic material member, said cores having axially-extending bores and a plurality of axially extending slots, said slots carrying a multi-phase, multi-pole armature winding, and
an inner stator comprising an iron core and a field coil, said iron core being magnetic, said field coil being wound axially.

2. An electric machine, as set forth in claim 1, comprising:
a rotor assembly including a shaft rotatably supported by said housing, said rotor assembly comprising first and second magnetic flux modifying member, each said magnetic flux modifying member comprising a ring of magnetic material and a plurality of circumferentially spaced and axially extending pole-forming magnetic segments, each said pole-forming magnetic segment having a proximal end at the respective ring and a distal end remote therefrom, said first and second magnetic flux modifying members being so oriented on said rotor assembly that the respective pole-forming magnetic segment of said first and second magnetic flux modifying member are interleaved such that the distal ends of the pole-forming magnetic segments of the first magnetic flux modifying member are in substantial planar alignment with the proximal ends of the pole-forming magnetic segments of the second magnetic flux modifying member, a hollow magnetic cylinder carrying a plurality of radially magnetized permanent magnets at its outer lateral surface, said permanent magnets being separated from each other, adjacent ones of said plurality of permanent magnets having opposite magnetic polarity, each of said permanent magnets being axially aligned with a respective said pole-forming magnetic segment, each of said plurality of permanent magnets further being spaced axially from the respective axially adjacent magnetic flux modifying member, said first and second magnetic flux modifying member and said hollow magnetic cylinder being firmly mechanically connected to each other and being disposed in the space between said outer stator and said inner stator, and
said field coil bi-directionally energizable to establish first and second magnetic polarities of said magnetic flux modifying members, said first magnetic polarity establishing magnetically homopolar pairs of axially aligned pole-forming magnetic segments and permanent magnets, and said second polarity establishing magnetically heteropolar pairs of axially aligned pole-forming magnetic segments and permanent magnets.
